(19) United States
(12) Patent Application Publication
(10) Pub. No.: US 2024/0063649 A1
(43) Pub. Date: Feb. 22, 2024

(54) CHARGING STATION FOR SIMULTANEOUSLY CHARGING A PLURALITY OF BATTERIES

(71) Applicant: Honda Motor Co., Ltd., Tokyo (JP)

(72) Inventor: Kyusang Ro, Chapel Hill, NC (US)

(21) Appl. No.: 17/890,048

(22) Filed: Aug. 17, 2022

(51) Int. Cl. H02J 7/00

(52) U.S. Cl. CPC H02J 7/00714; H02J 7/0048; H02J 7/0013

(57) ABSTRACT

A charging station for charging a plurality of batteries includes a charging terminal for charging a primary battery of the plurality of batteries in a first charging mode and a second charging mode, and at least one electrical outlet to enable connection of at least one external charger to enable a charging of at least one secondary battery of the plurality of batteries. The charging station also includes a controller configured to determine if the primary battery is connected to the charging terminal, and determine a charging current being supplied to the primary battery upon determination that the primary battery is connected to the charging terminal. The controller is configured to control the charging of the at least one secondary battery to limit a total charging current of the charging station equal to or below a threshold value.

### BACKGROUND

The disclosed subject matter relates, generally to, a charging station. More particularly, the disclosed subject matter relates to charging station having a charging terminal and at least one electrical outlet to enable a connection of at least one external charger to simultaneously charge a plurality of batteries.

Now a days, the garden equipment are generally electrically powered tools, and include similar type of batteries. For example, an electrical lawn mower and an electrical trimmer have same type of batteries. Users, generally, wish to quickly charge each of the multiple batteries. However, for so doing, a user either needs to have multiple chargers for quick charging of the multiple batteries simultaneously, or charge one battery at a time. Charging batteries sequentially with one battery being charged at a time increases overall charging time, and is undesirable to the users. Also, using multiple chargers for simultaneously charging the multiple batteries is expensive. Moreover, a quick charger supplies a relatively higher current to a battery for quick charging. Accordingly, multiple quick chargers, during simultaneously charging of the multiple batteries, draw a large amount of current from an electrical power supply, causing a blowing of a fuse of the electrical power supply, which is undesirable.

### SUMMARY

In accordance with one embodiment of the present disclosure, a charging station for charging a plurality of batteries is provided. The charging station includes a charging terminal for charging a primary battery of the plurality of batteries in a first charging mode and a second charging mode, and at least one electrical outlet to enable connection of at least one external charger to enable a charging of at least one secondary battery of the plurality of batteries. The charging station also includes a controller configured to determine if the primary battery is connected to the charging terminal, and determine a charging current being supplied to the primary battery upon determination that the primary battery is connected to the charging terminal. The controller is configured to control the charging of the at least one secondary battery to limit a total charging current of the charging station equal to or below a threshold value.

In accordance with another embodiment of the present disclosure, a charging station for charging a plurality of batteries is provided. The charging station includes a charging terminal for charging a primary battery of the plurality of batteries in a first charging mode and a second charging mode, and at least one electrical outlet to enable connection of at least one external charger to enable a charging of at least one secondary battery of the plurality of batteries. The at least one external charger is a slow charge. The charging station also includes a controller configured to determine if the primary battery is connected to the charging terminal, and determine a charging current being supplied to the primary battery upon determination that the primary battery is connected to the charging terminal. The controller is further configured to control the charging of the at least one secondary battery to limit a total charging current of the charging station equal to or below a threshold value.

In accordance with yet a further embodiment of the present disclosure, a method for charging a plurality of batteries is provided. The method includes determining, by a controller, if a primary battery of the plurality of batteries is connected to a charging terminal of a charging station. The charging terminal is configured to charge the primary battery in a first charging mode and a second charging mode. The charging station further includes at least one electrical outlet and at least one secondary battery of the plurality of batteries is connected to the at least one electrical outlet via at least one external charger. The method also includes determining, by the controller, a charging current being supplied to the primary battery upon determination that the primary battery is connected to the charging terminal, and controlling the charging of the at least one secondary battery to limit a total charging current of the charging station equal to or below a threshold value.

### BRIEF DESCRIPTION OF THE DRAWINGS

Certain embodiments of the present disclosure will be better understood from the following description taken in conjunction with the accompanying drawings in which:

FIG. 1 is a block diagram of a charging station having a plurality of electrical outlets and a plurality of external charger connecting a plurality of secondary batteries with the plurality of electrical outlets and a primary battery connected to a charging terminal, according to an embodiment of the disclosure; and

FIG. 2 is a block diagram of the charging station having the plurality of electrical outlets and a plurality of external charger connecting a plurality of secondary batteries with the plurality of electrical outlets, according to an embodiment of the disclosure.

### DETAILED DESCRIPTION OF EXEMPLARY EMBODIMENTS

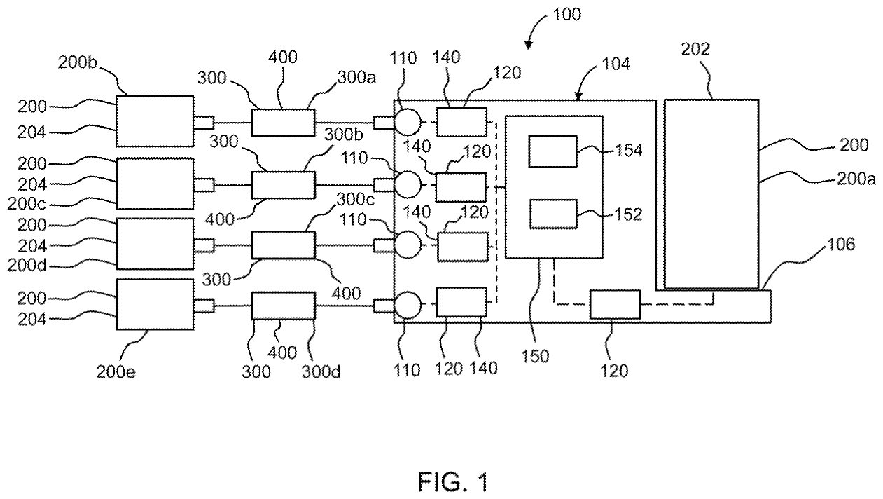

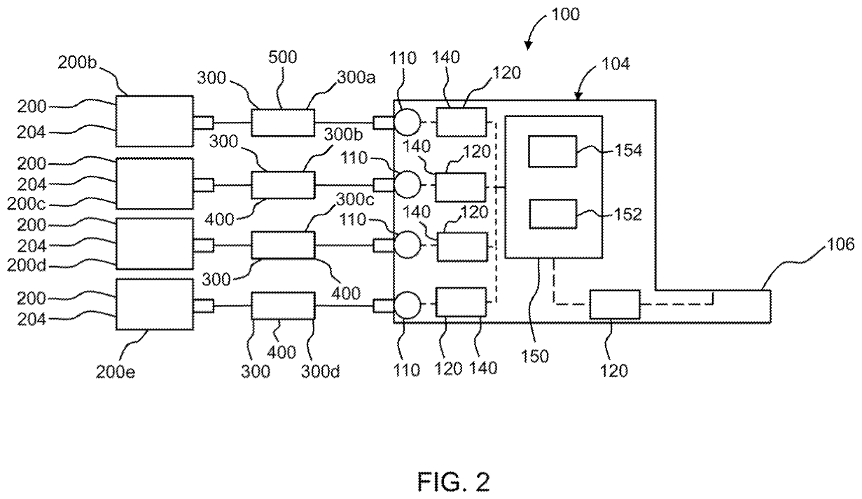

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-2, wherein like numbers indicate the same or corresponding elements throughout the views.

FIGS. 1 and 2, a block diagram of a charging station 100 suitable to charge a plurality of batteries 200 is shown. The charging station 100 may be suitable to charge the batteries of one or more garden equipment, for example, an electric lawn mower. However, it may be appreciated that the charging station 100 may be configured to charge batteries used in any equipment known in the art. The charging station 100 is a quick charger 104 having a charging terminal 106 to charge one of the plurality of batteries 102, for example, a primary battery 202, and at least one electrical outlet/socket 110 to facilitate remaining, for example, at least one secondary battery 204, of the plurality of batteries 200 connected to the at least one electrical outlet 100 via an at least one external charger 300. Accordingly, the at least one secondary battery 204 is electrically connected to the at least one external charger 300 which in turn is connected to the at least one electrical outlet 110 of the charging station 100. In the embodiment, the quick charger 104 enables a quick charging of the primary battery 202 which is connected to the charging terminal 106, and enables the charging of the primary battery 202 in a constant current mode and a constant voltage mode. The quick charger 104 charges the primary battery 202 in the constant current mode when a charge of the primary battery 202 is below a predetermined value, and charges the primary battery 202 in the constant voltage mode thereafter to fully charge the primary battery 202. In an embodiment, the at least one external charger 300 connected to the at least one electrical outlet 106 of the charging station 100 is a slow charger and configured to slowly charge the at least one secondary battery 204.

Further, the charging station 100 includes a plurality of relays 120 associated with the at least one electrical outlet 110 and the charging terminal 106 to control charging currents to be supplied to each of the at least one external charger 300 (i.e., secondary batteries 204) and the charging terminal 106. Accordingly, one relay 120 is connected to one electrical outlet 110 to control the flow of the charging current to the associated electrical outlet 110, and hence associated secondary battery 204. In an embodiment, the relay 120 is a field effect transistor 130 (FET) to enable and disable the flow of the charging current to the associated electrical outlet 110 as well as to control an amount of the charging current being supplied to the associated electrical outlet 110, i.e., the associated secondary battery 204. Further, the FET 130 is configured to sense/determine a charging current rating of the associated external charger 300 at which the each of the external charger 300 is configured to charge the associated secondary battery 204.

Additionally, the charging station 100 includes a controller 150 configured to control the relays 120 to control a total charging current of the charging station 100 as well as the charging current provided to each of the plurality of batteries 200. Further, the controller 150 is configured to determine if a battery 200 is attached to the charging terminal 106 of the quick charger 104 and assigns/determines the battery 200 connected to the charging terminal 106 as the primary battery 202 of the plurality of batteries 200, as shown in FIG. 1. Further, the controller 150 is configured to determine if one or more batteries 200 of the plurality of batteries 200 is connected to the one or more electrical outlets 110 via the one or more external chargers 300, and is configured to assign/determine the one or more batteries 200 connected to the one or more electrical outlets 104 as the secondary batteries 204. For example, as shown in FIG. 1, the controller 150 assigns a first battery 200a of the plurality of batteries 200 as the primary battery 202, and assigns a second battery 200b, a third battery 200c, a fourth battery 200d, and a fifth battery 200e as the secondary batteries 204.

In an embodiment, the controller 150 may include a processor 152 for executing specified instructions, which controls and monitors various functions associated with charging station 100, and its components, for example, the relays 120, the charging terminal 106, and the electrical outlets 110, etc. The processor 152 may be operatively connected to a memory 154 for storing instructions related to the control of the charging station 100.

The memory 154 may be integrated into the controller 154, but those skilled in the art will understand that the memory 154 may be separate from the controller 150 but onboard the charging station 100, and/or remote from the controller 150 and the charging station 100, while still being associated with and accessible by the controller 150 to store information in and retrieve information from the memory 154 as necessary during the operation of the charging station 100. Although the processor 152 is contemplated, it is also possible and contemplated to use other electronic components such as a microcontroller, an application specific integrated circuit (ASIC) chip, or any other integrated circuit device.

Further, the controller 150 may be configured to determine a charge level (i.e., charge) of the primary battery 202, and may control a charging current being supplied to the primary battery 202 based on the charge level of the primary battery 202. In an embodiment, the controller 150 is configured to charge the primary battery 202 in a quick charging mode (i.e., constant current mode) when the charge level of the primary battery 202 is below a predetermined value. The controller 150 is also configured to charge the primary battery 202 in the slow charging mode (i.e., the constant voltage mode) when the charge level of the primary battery 202 is above the predetermined value. Accordingly, the controller 150 is configured to the charge the primary battery 200 in the constant current mode at a first charging current till the charge level of the primary battery 202 reaches the predetermined value, and is configured to shift the charging of the primary battery 202 from the constant current mode to the constant voltage mode in response to the charge level being equal to the predetermined value. Subsequently, the controller 150 is configured to the charge the primary battery 202 in the constant voltage mode till the primary battery 202 is fully charged. In an embodiment, the first charging current may be a lesser of a first current value and a maximum permissible current of the primary battery 204. In some embodiments, the first current value is 10 ampere.

Moreover, the controller 150 is configured to monitor the charging current provided to the charging terminal 106 at any instant, and controls the charging of the secondary batteries 204 such that a total charging current of the charging station 100 remains equal to or below the threshold value. In some embodiments, the threshold value corresponds to a current value at which a fuse of an external power supply to the charging station 100 is blown. In an example embodiment, the threshold value is 15 ampere.

In an embodiment, each of the plurality of batteries 200, as shown in FIG. 2, is connected to the electrical outlets 110 of the charging station 110 via the external chargers 300. In such a case, the controller 150 detects an absence of a connection of a battery (i.e., primary battery 202) to the charging terminal 106. Accordingly, the controller 150 detects the plurality of secondary batteries 204, for example, the second battery 202b, the third battery 202c, the fourth battery 202d, and fifth battery 202e, as shown in FIG. 2, connected to the charging station 110, and the controller 150 enables or disables the charging of the plurality of secondary batteries 204 as well as amount of charging current being provided to each secondary battery 204 such that the total charging current remains below or equal to the threshold value. In some embodiments, each of the external chargers 300 is slow charger 400. In such a case, a maximum charging current provided to a battery 200 corresponds to a current rating of the associated external slow charger 400. For example, a secondary battery 204 is connected to the charging station 100 via an external charger 300 having current rating of 3 ampere. In such a case, the controller 150 may control the associated relay 120 to provide a maximum of 3 ampere current to the associated secondary battery 204. Further, the controller 150 may disable the charging of one or more secondary batteries 204 when controller 150 determines that the total charging to simultaneously charge each of the secondary batteries 204 is above the threshold value. In such a case, the controller 150 may enable charging of some of the secondary batteries 204 initially to keep the total charging current equal to or below the threshold value, and keep initiating the charging of the remaining secondary batteries 204 depending on the total charging current after completion of the charging of the one or more secondary batteries 204.

In some embodiments, as shown in FIG. 2, the controller 150 determines that one of the external chargers 300 is a quick charger 500, while remaining of the external chargers 300 are slow chargers 400. In such a case, the controller 150 may prioritize the charging of the secondary battery 204 connected to the quick external charger 500, and enables or disables the charging of the remaining secondary batteries 204 that are connected to the slow chargers 400 to keep the total charging current equal to or below the threshold value. In an embodiment, the controller 150 may control the quick external charger 500 in a quick charging mode to the charge the associated secondary battery 204 till the charge of the associated secondary battery 204 reaches the predetermined value, and thereafter controls the charging of the associated secondary battery 204 in the slow charging mode to fully charge the associated secondary battery 204. In an embodiment, in the quick charging mode, the controller 150 controls the charging current to be a lesser of the first charging current and the maximum permissible current of the associated secondary battery 204.

An example method of charging the plurality of batteries 200 is explained according to an embodiment, as shown in FIG. 1, of the disclosure. In the embodiment, as shown in FIG. 1, one of the plurality of batteries 200, for example, the first battery 200a is connected to the charging terminal 106, and remaining of the plurality of batteries 200, for example, for example, the second battery 200b, the third battery 200c, the fourth battery 200d, and the fifth battery 200e are connected to the four electrical outlets 110 via four external chargers 300. In the illustrated example embodiment, each of the external chargers 300 is a slow charger 400 and configured to supply electrical current to the associated secondary battery 204 according to respective charging current rating. In an example embodiment, a first external charger 300a is configured to the charge the second battery 200b at a maximum of 3 ampere current, and the second external charger 300b is configured to charge the third battery 200c with a maximum of 2 ampere current. Similarly, the third external charger 300c is configured to charge the fourth battery 200d with a maximum of 1 ampere current, while the fourth external charger 300d is configured to charge the fifth battery 200e with a maximum of 4 ampere current.

Also, in the example embodiment, the first battery 200a that is connected to the charging terminal 106 has a charge less than the predetermined value. Accordingly, the controller 150 determines the first battery 200a as the primary battery 202 and remaining batteries 200b, 200c, 200d, 200e as the secondary batteries 204. Therefore, the charging station 100 initially start charging the first battery 200a in the constant current mode with the first charging current. In the example embodiment, the first charging current for the first battery 200a in the constant current mode is 10 ampere. Further, the threshold value of the current, for the charging station is, for example, 15 ampere. The threshold current corresponds to a current at which a fuse of the external power supply to which the charging station 100 is electrically connected is blown. Accordingly, the controller 150 initiates the charging of the first battery at 10 ampere. Moreover, the controller 150 also initiates the charging of one or more secondary batteries 204, for example, the second battery 200b and the third battery 200c, and disables the charging of the fourth battery 200d and the fifth battery 200e to keep the total charging current of the charging station equal to or below the threshold value (i.e., 15 ampere). During charging of the three batteries 200a, 200b, 200c, the controller 150 may keep monitoring the charge level of the batteries 200a, 200b, 200c, and controls the charging of the three batteries 200a, 200b, 200c based on the charge level of each of three batteries 200a, 200b, 200c. Further, the controller 150 may keep monitoring the charging current of the three batteries 200a, 200b, 200c, and total charging current of the charging station 100. The controller 150 may initiate the charging of the fourth battery 200d and/or the fifth battery 200e as soon as the controller 150 determines that a difference between the total charging current being provided to the three batteries 200a, 200b, 200c and the threshold current value is greater than or equal to a charging current rating of the third external charger 300c and/or the fourth external charger 300d.

In an embodiment, the controller 150 shifts the charging of the first battery 200a from the constant current mode to the constant voltage mode in response to the charge level of the first battery 200a being equal to or greater the predetermined value. Thereafter, the controller 150 monitors the current provided to the first battery 200a and may initiate the charging of the fourth battery 200d and/or the fifth battery 200e depending on the total charging current of the charging station to keep the total charging current equal to or below the threshold value. In the example embodiment, the controller 150 initiates the charging of both the fourth battery 200d and the fifth battery 200e when the first battery 200a is being charged in the constant voltage mode as the total charging current provided to all the batteries 200a, 200b, 200c, 200d, 200e will be 13 ampere assuming that the maximum charging current provided to the first battery 200a is 3 ampere in the constant voltage mode. In this manner, the controller 150 controls the charging of the secondary batteries 204 (i.e., enable or disable the charging of the secondary batteries 204) along with the primary battery 202 to keep the total charging current equal to or below the threshold value, while allowing the simultaneous charging of the plurality of batteries 200—thereby prevents the blowing of the fuse of the external power supply.

A method of charging the plurality of batteries 200 in a scenario where each of the plurality of batteries 200 is connected to the charging station 100 via the external chargers 300, as shown in FIG. 2, is now described. The method is explained with reference to FIG. 2 that shows four batteries 200b, 200c, 200d, 200e connected to the charging station 100 via four external chargers 300, and the charging terminal 106 is free from the connection to a battery. In such a scenario, the controller 150 determines an absence of the primary battery 202 connected to the charging terminal 106, while detects presence of a plurality of secondary batteries 204, for example, the second battery 202b, the third battery 200c, the fourth battery 200d, and fifth battery 200e, connected to the four electrical outlets 110 via the first external charger 300a, the second external charger 300b, the third external charger 300c, and the fourth external charger 300d, respectively. In the example embodiment, the first external charger 300a is a quick external charger 500 and is configured to charge the second battery 200b in a constant current mode and a constant voltage mode, while the second external charger 300b, the third external charger 300c, and the fourth charger 300d are slow chargers 400.

Accordingly, the first charger 300a may charge the first battery 200a in the constant current mode at the first charging current when the charge level of the second battery 200a is below the predetermined value. In an embodiment, the first charging current may be lesser of a maximum permissible current of the second battery 200b and the first current value. In an embodiment, the first current value may be 10 ampere, and the controller 150 charges the second battery 200a at 10 ampere current in the constant current mode. Also, the controller 150 prioritizes the charging of the second battery 200b with the first charging current, and controls the charging of the remaining secondary batteries 200c, 200d, 200e such that the total charging current of the charging station 100 remains equal to or below the threshold value, for example 15 ampere. In an example, the second external charger 300b, the third external charger 300c, and the fourth external charger 300d are slow chargers 400, and have charging current ratings of 3 ampere, 2 ampere, and 1 ampere, respectively.

In such a case, the controller 150 may initiate the charging of the third battery 200c and the fourth battery 200d along with the second battery 200b and disable the charging of the fifth battery 200e, thereby keeping the total charging current of the charging station 100 equal to the threshold value, for example, 15 ampere. As soon as the controller 150 detects the shift of the charging of the second battery 200b from the constant current mode to the constant voltage mode, or completion of the charging of one of the third battery 200c and the fourth battery 200d, the controller 150 may enable the charging of the fifth battery 200e. In this manner, the controller 150 is configured to simultaneously charge the plurality of batteries 200, while preventing a blowing of the fuse of the external power supply.

In some embodiments, the first external charger 300a, the second external charger 300b, the third external charger 300c, and the fourth external charger 300d, each is a slow charger 400, and the controller 150 detects the absence of a battery connected at the charging terminal 106. In such a case, the controller 150 may control the charging of one or more of the batteries 200 to keep the total charging current equal to or below the threshold value. The controller 150 may provide the charging currents to the batteries 200 depending on the charge current ratings of the external chargers 300. Also, the controller 150 may disable the charging of the one or more secondary batteries 204 to keep the total charging current below or equal to the threshold value. In such a case, one more secondary battery 204, whose charging was initially disabled, are charged only after completion of the charging of one or more batteries whose charging was initial enabled. Accordingly, the charging station 100 facilitates charging of the plurality of batteries simultaneously without blowing of the fuse of the external power supply.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A charging station for charging a plurality of batteries, the charging station comprising:
a charging terminal for charging a primary battery of the plurality of batteries in a first charging mode and a second charging mode;
at least one electrical outlet to enable connection of at least one external charger to enable a charging of at least one secondary battery of the plurality of batteries; and
a controller configured to
determine if the primary battery is connected to the charging terminal,
determine a charging current being supplied to the primary battery upon determination that the primary battery is connected to the charging terminal, and
control the charging of the at least one secondary battery to limit a total charging current of the charging station equal to or below a threshold value.

2. The charging station of claim 1, wherein the first charging mode is a quick charging mode and a second charging mode is a slow charging mode, wherein the controller is configured to
charge the primary battery in the first charging mode when a charge level of the primary battery is below a predetermined value, and
shift the charging of the primary battery to the second charging mode when the charge level of the primary battery is equal to or above the predetermined value.

3. The charging station of claim 1, wherein the at least one external charger includes at least one slow charger.

4. The charging station of claim 1, wherein the charging station include a plurality of relays to control flow of electric current to the at least one electrical outlet and the charging terminal.

5. The charging station of claim 1, wherein the controller determines an absence the connection of the primary battery to the charging terminal.

6. The charging station of claim 5, wherein
the at least one external charger includes a plurality of external chargers, and at least one secondary battery includes a plurality of secondary batteries connected to the charging station via the plurality of external chargers and one of the plurality of external chargers is a quick charger, and
the controller is configured to charge the secondary battery connected to the quick charger in a quick charging mode upon detection of the absence of the connection of the primary battery at the charging terminal.

7. The charging station of claim 6, wherein the controller is configured to
determine a charging current of the secondary battery connected to the quick charger, and
control the charging of remaining secondary batteries to maintain the total charging current of the charging station equal to or below the threshold value.

8. A charging station for charging a plurality of batteries, the charging station comprising:
a charging terminal for charging a primary battery of the plurality of batteries in a first charging mode and a second charging mode;
at least one electrical outlet to enable connection of at least one external charger to enable a charging of at least one secondary battery of the plurality of batteries, wherein the at least one external charger is a slow charger; and
a controller configured to
determine if the primary battery is connected to the charging terminal,
determine a charging current being supplied to the primary battery upon determination that the primary battery is connected to the charging terminal, and
control the charging of the at least one secondary battery to limit a total charging current of the charging station equal to or below a threshold value.

9. The charging station of claim 8, wherein the first charging mode is a quick charging mode and a second charging mode is a slow charging mode, wherein the controller is configured to
charge the primary battery in the first charging mode when a charge level of the primary battery is below a predetermined value, and
shift the charging of the primary battery to the second charging mode when the charge level of the primary battery is equal to or above the predetermined value.

10. The charging station of claim 8, wherein the charging station include a plurality of relays to control flow of electric current to the at least one electrical outlet and the charging terminal.

11. The charging station of claim 8, wherein the controller determines an absence the connection of the primary battery with the charging terminal.

12. The charging station of claim 11, wherein the controller is configured to control the charging of each of the secondary batteries such that the total charging current remain equal to or below the threshold value.

13. The charging station of claim 11, wherein
the at least one external charger includes a plurality of external chargers and one of the plurality of external chargers is a quick charger and remaining of the plurality of external chargers are slow chargers,
the at least one secondary battery includes a plurality of secondary batteries connected to the charging station via the plurality of external chargers and, and
the controller is configured to charge the secondary battery connected to the quick charger in a quick charging mode upon detection of the absence of the connection of the primary battery at the charging terminal.

14. The charging station of claim 13, wherein the controller is configured to
determine a charging current of the secondary battery connected to the quick charger, and
control the charging of remaining secondary batteries to maintain the total charging current of the charging station equal to or below the threshold value.

15. A method for charging a plurality of batteries, the method comprising:
determining, by a controller, if a primary battery of the plurality of batteries is connected to a charging terminal of a charging station, wherein the charging terminal is configured to charge the primary battery in a first charging mode and a second charging mode, and the charging station further includes at least one electrical outlet and at least one secondary battery of the plurality of batteries is connected to the at least one electrical outlet via at least one external charger;
determining, by the controller, a charging current being supplied to the primary battery upon determination that the primary battery is connected to the charging terminal; and
controlling the charging of the at least one secondary battery to limit a total charging current of the charging station equal to or below a threshold value.

16. The method of claim 15, wherein the first charging mode is a quick charging mode and a second charging mode is a slow charging mode, and the method further includes
charging the primary battery in the first charging mode when a charge level of the primary battery is below a predetermined value, and
shifting the charging of the primary battery to the second charging mode when the charge level of the primary battery is equal to or above the predetermined value.

17. The method of claim 15, wherein the controller determines an absence the connection of the primary battery to the charging terminal.

18. The method of claim 17, wherein the at least one external charger includes a plurality of external chargers, and the at least one secondary battery includes a plurality of secondary batteries connected to the charging station via the plurality of external chargers and one of the plurality of external chargers is a quick charger and remaining of the plurality of external chargers are slow chargers, and the method further includes
controlling the charging the secondary battery connected to the quick charger in a quick charging mode upon detection of the absence of the connection of the primary battery to the charging terminal.

19. The method of claim 18 further includes
determining a charging current of the secondary battery connected to the quick charger, and
controlling the charging of remaining secondary batteries to maintain the total charging current of the charging station equal to or below the threshold value.

20. The method of claim 15, wherein the charging station includes a plurality of relays to control flow of electric current to the at least one electrical outlet and the charging terminal.
